(19) United States
(12) Patent Application Publication
(10) Pub. No.: US 2020/0271310 A1
(43) Pub. Date: Aug. 27, 2020

(54) Bulk Energy Storage Process

(71) Applicant: Calvin Billings, Lake Charles, LA (US)

(72) Inventor: Calvin Billings, Lake Charles, LA (US)

(21) Appl. No.: 16/558,520

(22) Filed: Sep. 3, 2019

Related U.S. Application Data
(63) Continuation-in-part of application No. 16/252,533, filed on Jan. 18, 2019, now abandoned.
(60) Provisional application No. 62/619,766, filed on Jan. 20, 2018.

(51) Int. Cl. F22B 33/12; F01K 11/02; F01K 15/00; C10J 3/82; C01B 3/34; C01B 3/52

(52) U.S. Cl. CPC F22B 33/12; C01B 2203/1058; F01K 15/00; C10J 3/82; C01B 3/34; C01B 3/52; C10J 2300/1612; C10J 2300/165; C10J 2300/1675; C01B 2203/0233; C01B 2203/84; C01B 2203/0475; C01B 2203/0485; C01B 2203/0415; C01B 2203/0833; F01K 11/02

(57) ABSTRACT

A multi stage set of molten salt based processes for coal gasification, recovery of sulfur from hydrogen, capture of CO₂ from gases and processes to store generated electrical energy for later use when it is needed in which excess power can be used to decarbonize fossil fuel to produce hydrogen that can be stored, sequester CO₂, and regenerate the hydrogen back to electricity using an advanced power cycle.

### CROSS REFERENCE TO RELATED APPLICATIONS

This application claims benefit of U.S. application Ser. No. 16/252,533, filed Jan. 18, 2019 which claims benefit of provisional application 62/619,766 filed Jan. 20, 2018 and which is a continuation-in-part of U.S. application Ser. No. 14/837,256, filed Aug. 27, 2015 which application claims benefit of Provisional Application Ser. No. 62/042,574 filed Apr. 27, 2014, the contents and disclosures of which is incorporated herein by reference in its entirety for all purposes.

### BACKGROUND

### Field of Invention

This invention relates to molten salt-based processes for coal gasification, recovery of sulfur from hydrogen, capture of CO₂ from gases and processes to store generated electrical energy for later use when it is needed in which excess power can be used to decarbonize fossil fuel to produce hydrogen that can be stored, sequester CO₂, and regenerate the hydrogen back to electricity using an advanced power cycle.

### Background

Since inception, the electric utility has been founded and operated based on large, central generating plants using coal, gas and nuclear boilers generating steam for conversion to electric power that is transported over wires to where it is consumed. All the generating plants, including gas turbines, were designed to operate most efficiently when operating around the clock. For example, it can take a week to start up a large boiler and bring it up to temperature for operation. After all the metal and refractory parts have heated and expanded, they can be idled back 50 to 70 percent when demand is reduced. Gas turbines can be idled back somewhat and even be shut down and restarted when peak demand occurs, but it takes 30 minutes to reach peak because they generally have a boiler associated with the operation which needs a slow heat-up.

To compensate for varying demand periods the industry created two price levels: on-peak from about 7 AM to about 7 PM, and off-peak from 7 PM to 7 AM. Actually, peak is 3 hours from 6 am to 9 AM and then 5 hours from 4 PM to 9 PM. Almost opposite of this maximum demand, solar power is greatest from 9 AM to 4 PM when the sun is shining most intently. Wind power is greatest at night when demand is lowest. It is easy to understand what has happened. The electric utility industry has been grossly disrupted by this new surge of power when least needed. To make room for this excess power, regulations mandate that traditional sources must cut back production. As previously noted, they are not designed to cycle as it is not economically viable because efficiency is greatly impaired. Nor is it feasible to shut down for more than 20 percent of the time as this is below their break-even point. The same principle applies to nuclear and gas plants. Proof, is over half of the nation's 500 coal plants have been closed, as have a dozen nuclear and relatively new gas turbine plants.

This has all been a result of measures to curtail CO₂ which is affecting climate change. The coal plants have switched to burning gas where they can, and it has been effective for reducing CO₂, but it has been reported that by now all have been switched to gas that can be. The coal, nuclear and gas plants are simply uneconomic to operate at the low electric prices brought about by reduced demand and surplus power.

Ten years ago, a few could see this problem developing but it was commonly expressed “that technology would solve the problem” most likely by post combustion flue gas scrubbing or coal gasification. That hasn't happened, and no one now is even suggesting it because it has been an economic failure. If this were not the case, these two technologies would have been installed instead of closing plants.

Renewable energy advocates foresee the time when all the power will be generated by solar and wind. A larger group, including the International Energy Agency, proclaim that fossil fuel will be needed to supply at least 60 percent of the fuel base for decades to come.

Bulk energy storage as described herein works for both camps. It teaches how to use off peak power to convert fossil fuel to hydrogen, store the hydrogen, and then convert the hydrogen back to electricity. Most importantly this is a new concept based on proven technology, using commercial equipment. There is no need for a long development period.

### BRIEF DESCRIPTION OF DRAWINGS

A more complete understanding of the present invention and certain advantages thereof may be acquired by referring to the following description in consideration with the accompanying drawings, in which like reference numbers indicate like features, and wherein:

FIG. 1 is a schematic view of an embodiment of the invention showing a sulfur removal process.

FIG. 2 is a schematic view of an embodiment of the invention showing a carbon dioxide removal process.

FIG. 3 is a schematic view of an embodiment of the invention showing a coal gasification process.

FIG. 4 is a schematic view of an embodiment of the invention showing gas conversion process.

FIG. 5 is a schematic view of an embodiment of the invention showing an electrical generation peak optimization electric process.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF EMBODIMENTS

In the following detailed description, reference is made to the accompanying drawings that form a part hereof, and in which is shown by way of illustration specific implementations (embodiments) which may be practiced. These implementations are described in sufficient detail to enable those skilled in the art to practice the implementations, and it is to be understood that other implementations may be utilized. Further, logical, mechanical, and other changes may be made without departing from the scope of the implementations. The following detailed description is, therefore, not to be taken in a limiting sense.

Molten salts are excellent heat transfer medium, operating between 1000° F.-2000° F., they are catalytic, and are easily transportable and less damaging to a processed product. Additives can be incorporated for specific reactions such as absorption and combining.

This invention includes a modular equipment design created to assemble five basic equipment item embodiments to effect desired reactions necessary for processing fossil fuels to make the conversion to clean hydrogen. The primary item is an induction electrical heater such as that made by Ajax-Tocco used in the metal melting industry.

A suitable conventional molten salt pump can be purchased from Nagel Pump Co. A static mixer such as that made by Komax Co. is used to mix molten salt with the gasses to be treated, and the final item is a heat exchanger such as that mage by CES Co. is used for attaining greater efficiency from the flowing fluids. Functionally equivalent equipment to tat above identified is also suitable.

Four basic processes are described showing how they can be used to achieve the results aspired to with this work: clean hydrogen production, storage, and electrical generation with CO₂ sequestration. They are termed herein as: Sulf-X, for H₂S removal from gas streams, Carb-X, for removal of CO₂ from gas streams, Coal-X, for gasifying coal/coke to hydrogen and CO₂, and Hydro-X, for reforming natural gas to hydrogen and CO₂.

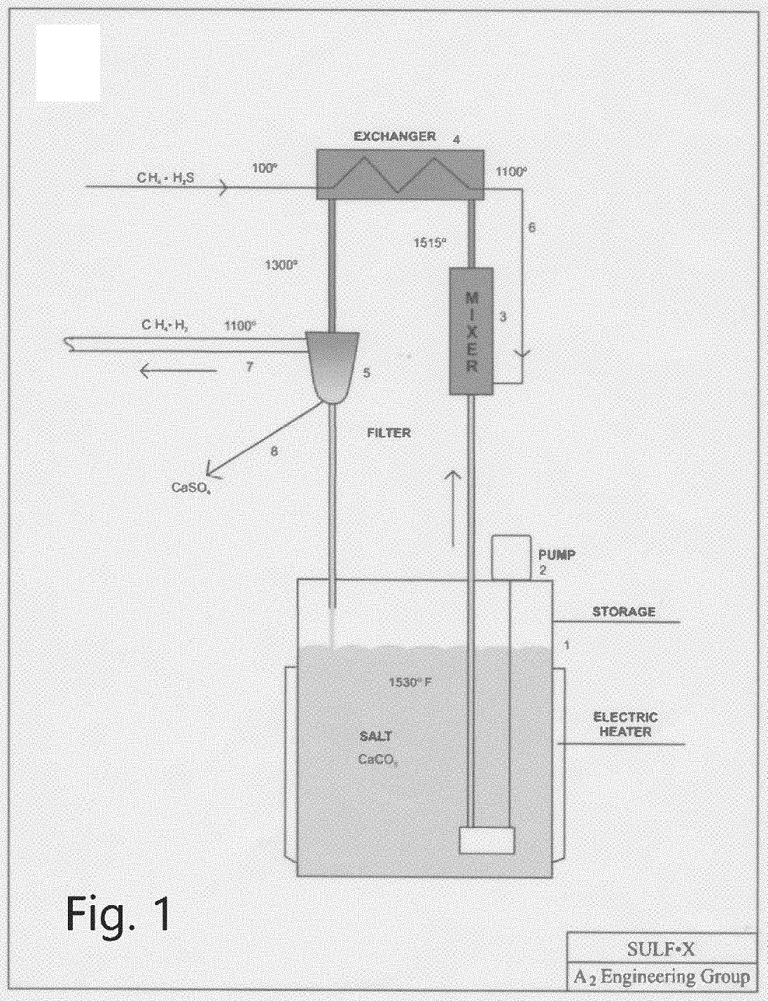

About 15% of the gas fields around the world contain varying quantities of H₂S, and it must be reduced to about 400 ppm to meet pipeline specifications. There are several available processes to remove H₂S and they all convert the hydrogen to water, which is a waste of a valuable resource. The process of an embodiment of the present invention termed the Sulf-X process, recovers the hydrogen (FIG. 1). In the Sulf-X drawing (FIG. 1), the bottom storage vessel (1) is fitted with an electrical heater to maintain an internal salt temperature between about 1520-1530° F. The salt can be a single or mix of oxides, hydroxides, chlorides, sulfates, or carbonate salts. An absorbent of oxide, hydroxide, chloride, sulfate, or carbonate or mixture thereof comprising any percentage to absorb sulfur can be used. In a prototype demonstration, a low-cost bath of NaOH was used with a 10% content of CaCO₃ for 100% H₂S conversion to H₂ and CaSO₄.

A pump, (2) lifts the salt and pumps it through a static mixer (3). The gas containing H₂S is piped into the mixer where the gas and salt are intermixed for sufficient contact to cause the H₂S to be split into Sulfur (S) and H₂. The Sulfur immediately reacts with the entrained CaCO₃ to form CaSO₄ and the H₂ is entrained in the salt. The salt and other components enter an exchanger (4) to cool the salt by exchange with the inflowing gas to be treated in the mixer through line (6). From the exchanger, the flow enters a filter (5) which strains out the solid CaSO₄ from the liquid salt. Gaseous components, H₂, CH₄, and possibly CO₂ leave the liquid and exit the filter at line (7). CaSO₄ exits the filter at line (8). The CaSO₄ is identified as natural calcite and is used to make wallboard and other building products such as bricks and road material. It has added value because it is calcined by the molten salt and will not absorb water. A key feature is to locate the auxiliary equipment above the storage vessel so that with routine or accidental shutdowns, the salt will drain back to storage where it can be heated.

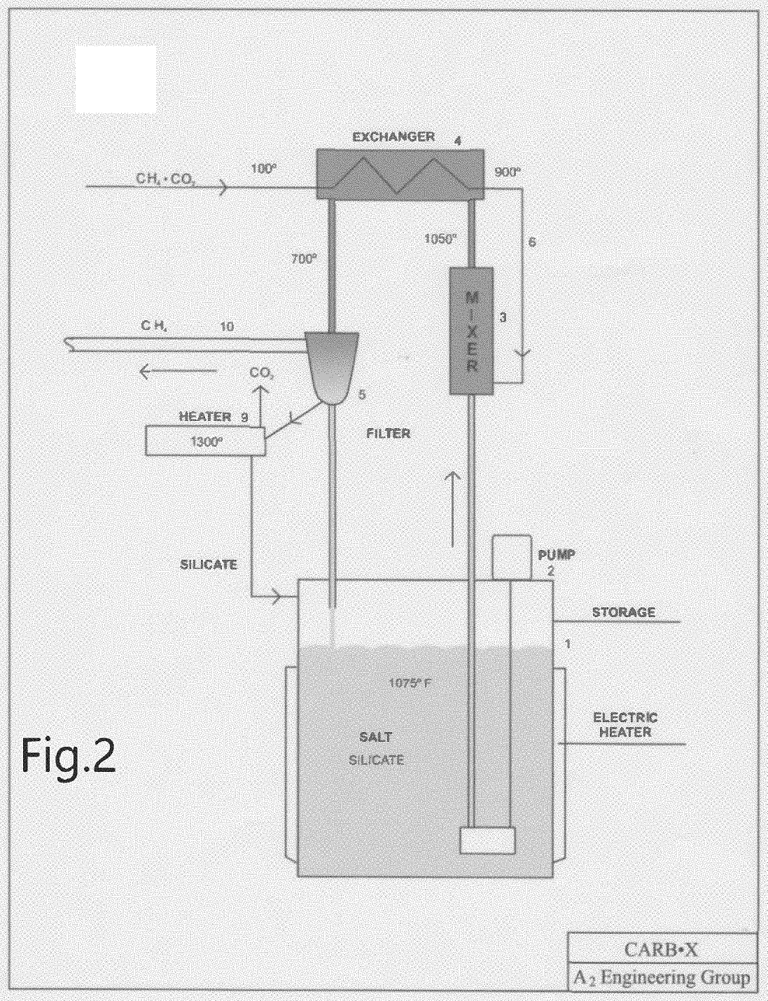

Another embodiment is a process for removal of CO₂ from gas streams and is termed herein the Carb-X process (FIG. 2). The equipment arrangement is identical to that of the Sulf-X process except for an added regeneration heater (9). In this embodiment, the preferred salt is a carbonate mix, although others previously listed could be used. A typical mix is one third each of lithium carbonate, potassium carbonate, and sodium carbonate. The ratio can be varied to adjust the cost of the mix and the melting point, without affecting the performance in a significant way. A single or mixed carbonate contains lithium ortho silicate (Li4SiO₄) for absorbing CO₂. A single or mixed carbonate contains lithium ortho silicate (Li₄SiO₄) for absorbing CO₂. It is not generally available except in very expensive gram quantities from laboratory suppliers. In research by others it was prepared by mixing two parts of lithium carbonate and one-part silicon dioxide powder and making them into a water slurry, drying it, then grinding it into a powder and heating it for several hours at 1700° F. where it formed lithium ortho silicate. It was then ground into pellet size suitable for fluid bed operation. Others found it helpful to dope or coat it with carbonate salts. Published work with silicate began in 2002 in several universities around the world, particularly in Japan and Italy primarily using fluid beds with solids. It was found that lithium silicate was an excellent absorbent but in operation a fluid bed was not suitable due to attrition of the silicate. Tenaska, (Terasaka et al., “Absorption and Stripping of CO₂ with a Molten Salt Slurry in a Bubble Column at High Temperature”, Chem. Eng. Technol. 2006, 29, No. 9, 1118-1121) did a laboratory study of bubbling CO₂ through a two-inch column of molten salt containing lithium silicate and it proved to absorb well but revealed no way to commercially exploit it. Only very small quantities can be absorbed this way. In practice a gas will blow all the liquid from the container before there is sufficient contact between the gas and liquid. The traditional approach to contact gas and liquids for absorption is by spray or packed towers. Molten salt will freeze and plug nozzles and other tower internals when reduced to a spray. Packed towers will plug the packing with the solids in the salt. Static mixers, as described for the embodiments herein, have been used for blending liquids and gases for many years, but their use as a contactor for molten salt and gas is a novel approach for CO₂ and H₂S removal. The justification for this assertion is that for the past 20 years there has been a worldwide search conducted by the most advanced research facilities at the expense of billions of dollars with no successful economic results. It is a prima facia fact that this cannot be assessed as obvious to anyone skilled in the art.

In preferred embodiments the silicon dioxide was ground to nano size before mixing with two parts lithium carbonate. The mix was placed in a reactor vessel and heated to 1645° F. when CO₂ began to evolve and continued for 45 minutes until it was no longer present. This indicated the reaction to lithium ortho silicate had occurred. A carbonate mix as described above was added to the reactor vessel to make a mix of 20% lithium ortho silicate. The salt bath was stirred to keep the solid silicate suspended. The temperature was lowered to 1075° F. and a mix of 5% CO₂ and air was bubbled through the bath and a sample captured from the vent gas. There was 0% CO₂ in the vent gas, indicating 100% removal.

The storage temperature is maintained at 1075° F. The silicate content can be from 10-30%, however, 20% is preferred. As in the previous description, the salt is pumped to the mixer where a CO₂ containing gas stream is fed into the mixer to be intermixed with the salt and silicate. The silicate immediately absorbs the CO₂, forming lithium carbonate (LiCO₃). The LiCO₃, being a solid, is filtered out and flows into a heater (9). Here the temperature of the LiCO₃ is increased to 1300° F. causing the carbonate to decompose back to silicate and be recycled to the storage vessel (1). CO₂ released from the carbonate flows out the exit (9) and is captured for further use. Gas containing CH₄ or H₂ exits (10) on the filter line (5).

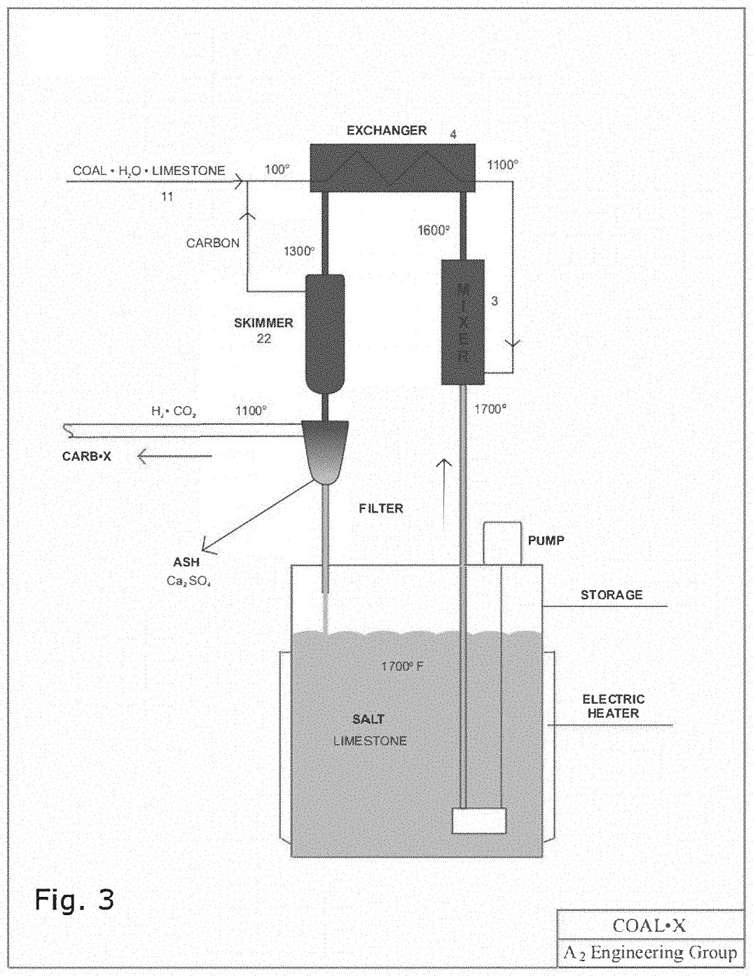

Another embodiment, termed Coal-X herein, gasifies coal and coke to hydrogen and CO₂ (FIG. 3). The results are the same as other gasification projects costing billions of dollars. Using the same equipment configuration as described above, a chloride salt mix of KCl and CaCl was used to gasify Illinois #6 coal at 1700° F. Finely ground limestone comprising about 15% of the salt is the sulfur absorbent. The salt is pumped through the mixer, as before. Coal, limestone, and water form a slurry, which is pumped into the mixer (3) after going through exchanger (4). Inside the mixer the chloride salt mix is contacted by the coal slurry where the two streams are mixed at 1700° F. and the reaction of C+H₂O→2H₂+CO₂ occurs very rapidly. From the exchanger, the salt flow enters a skimmer (22) where carbon is skimmed off and recirculated back into the coal feed line (11). The salt mix flows into the filter (5) where H₂ and CO₂ leave the salt as gas, and coal ash along with CaSO₄ exit the filter as a solid. Heating only the filtered solid to 1300° F. is much more efficient than heating the total volume of salt that contains the filtered solid. The advantage of using a mixer over a typical gasifier is economic. A mixer is about the size of a barrel and a typical gasifier is a tall tower over ten feet in diameter. This is the principal reason that coal gasification has never been commercialized for power production. With this system modular units can be shop fabricated with enough cost savings that a viable process can be deployed. The H₂ and CO₂ are conducted into a Carb-X unit to remove CO₂ prior to the hydrogen being blended into a pipeline, stored or used directly as fuel.

The H₂ and CO₂ are conducted into a Carb-X unit to remove CO₂ prior to the hydrogen being blended into a pipeline or used directly as fuel.

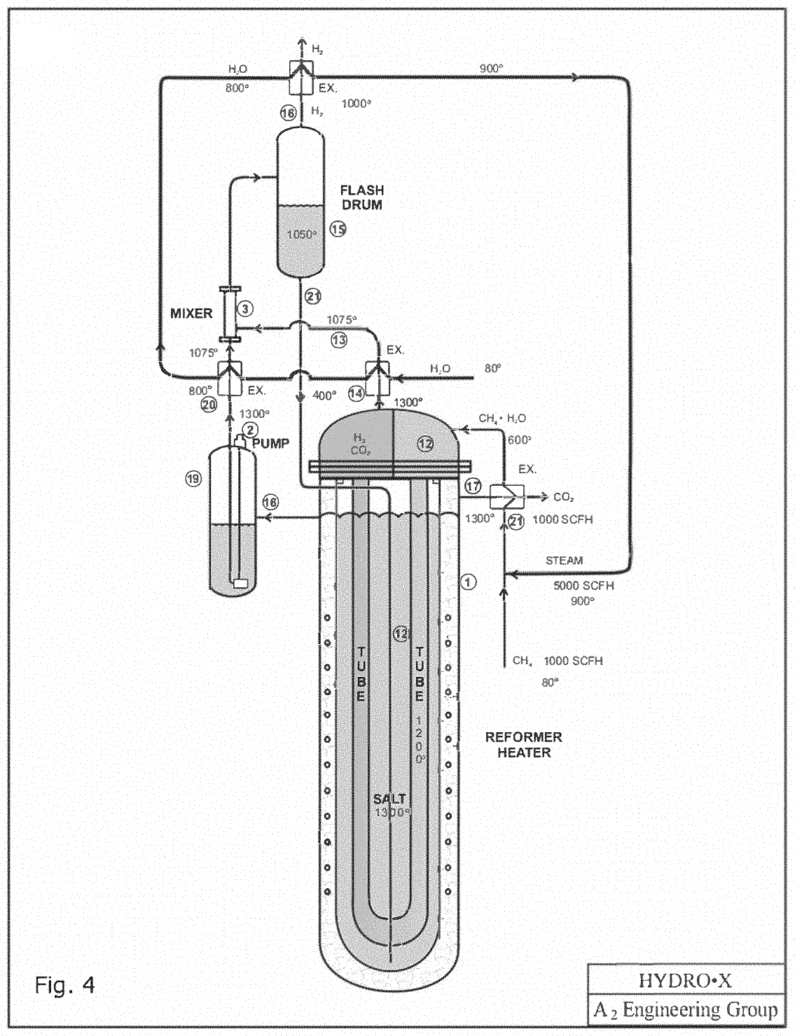

The fourth process embodiment, termed Hydro-X herein is a reformer of natural (SMR) gas to hydrogen (FIG. 4). The reactor vessel (1) differs in the respect that it has catalyst tubes (12) inside to be heated by molten salt. The salt surrounds the tubes and transfers heat from the 1300° F. salt to provide 1200° F. to a catalyst inside the tubes. Typically, in a Steam Methane Reformer (SMR) process the tubes are in a dry furnace box and burners for heating the tubes are on the bottom or sides of the furnace. The hot flue gas contacts the tubes to transfer heat to the inside. In the present process, molten salt surrounds the tubes and heat is conducted into the salt by contact of the vessel wall heated by the electric heater (coils in the wall as shown in FIG. 4). It is easy to understand the improved conductance of the liquid salt compared to conventional heated gas. A person can stick their hand into a 400° F. oven with no adverse effect but if it was 200° F. water they would be severely burned. The catalyst is a commercially available SMR catalyst that converts natural gas and water to H₂ and CO₂. The conventional SMR process is used commercially to manufacture 95% of all hydrogen used today. Natural gas with or without CO₂ and steam are fed into the tubes (12) at one end and hydrogen and CO₂ flow out the other end and are conducted through line (13) through an exchanger (14) into mixer (3). Here the gas and salt, the same combination as Carb-X, mix and remove the CO₂ by absorption with silicate. From the mixer, (3) the salt and gas flow into the flash drum, (15) where the hydrogen flows out the drum at line (16) and the CO₂ laden salt drains down line (21) to the bottom of vessel (1). The carbonate formed from the CO₂ and silicate flow up vessel (1) into the pump section at the top of the salt bath. Travel through the bath raises the temperature from 1070° F. to 1300° F., which releases the CO₂ that flows out of vessel (1) through line (17). Salt pumped from vessel (1) through line (18) goes through exchanger (19) to cool it from 1300° F. to 1070° F., the ideal temperature for CO₂ absorption.

Hydrogen Combustor.

Baseload coal and nuclear processes rely on boilers to produce steam to drive steam turbines. A high-pressure combustor has been developed by CEC through the U.S. Department of Energy (DOE) for burning a variety of fuels with oxygen and using the steam/CO₂ mix to drive a steam turbine (see FIG. 8). The same type combustor can be used to burn hydrogen with air to produce a steam/nitrogen mix. This has the benefit of not requiring an oxygen plant. The burner exhaust of nitrogen and steam is directed into the steam turbine as the driving force, eliminating the cost and inefficiency of a boiler.

The foregoing embodiment descriptions are directed to chemical applications of the invention. Described below are power storage application embodiments. There are several methods for storing hydrogen: in tanks, underground, porous solids like anhydrides and pipelines Tanks are generally too small to store more than a small quantity for special applications, they are inadequate for utility scale. Underground storage offers several variations. Depleted oil and gas formations are abundant in many locations and have been proven to be sealed from leakage. Many depleted and unmined coalbeds have also been used for gas storage. Where these underground formations don't exist, underground water aquifers are potentially useful. The volume needed is small and if the sand is sealed by caprock the water can be pressured back by the hydrogen to form a gas pocket. When hydrogen is withdrawn the water flows back purging hydrogen out. Hydrogen pipelines occasionally are available, and the natural gas network offers abundant storage, however, the gas and hydrogen need to be separated to obtain pure hydrogen. Often the pressure on the hydrogen process unit is sufficient to store underground. In other cases, it will be compressed. When withdrawn from storage, it is compressed to 1000-4000 psi for firing the hydrogen combustor. Air to the combustor is compressed to an equal pressure.

One power storage embodiment is a power cycle, where hydrogen is converted to electricity. Presently, nuclear and coal burning power plants convert fuel to steam in a boiler to power a steam turbine. This requires an elaborate water system to treat the water and to cool and condense it, so it can be recycled. A large segment of the water required is lost to the atmosphere as warm water vapor. Because of this loss, the efficiency is 40 percent or less for most traditional boilers. To improve efficiency, new equipment is designed to operate at much higher pressure, near 4000 psi. Combined cycle gas turbines can achieve a maximum of 60 percent because they reduce the size of the water cycle by two thirds, and therefore the losses.

When hydrogen is burned with air the combustion products are nitrogen and steam and no CO₂. Nitrogen is inert and is often used by steam turbine manufacturers as a substitute for steam in testing turbines. A featured concept of this process embodiment is to use the combination of nitrogen and steam from burning hydrogen to drive a steam turbine. Steam turbines can be purchased to accept steam pressures to 4000 psi and 1100° F. There are no hydrogen burning combustors available that can operate in this range except those that burn liquid hydrogen on space rockets. By leaving off the heat exchanger to gasify the liquid hydrogen rocket engines can be used to burn gaseous hydrogen and compressed air. The resultant nitrogen/steam exhaust can be used to power a conventional steam turbine. This eliminates a boiler and water treating/cooling plant to produce steam for power. The efficiencies are much greater and the capital costs much lower. Others have sought these same benefits by burning natural gas with liquid oxygen. An oxygen plant increases the cost greatly, and produces CO₂. Nevertheless, they have achieved technological success with powering a steam turbine, just not the economics. This experience can be transposed to hydrogen combustion which offers superior economics. The power cycle features the hybrid rocket engine purchased from one of several space manufacturers, and a steam turbo/generator from a selection of vendors.

A steam turbine is used as a topping turbine to take the brunt of pressure and temperature from the combustor. It will operate at a back pressure above the condensing temperature of the steam. Nitrogen, being non-condensable, interferes with the condensing phase. An expander will be used on the back end of the steam turbine to allow the steam and nitrogen mix to expend the final energy and exhaust to atmosphere. In some situations, it may be desirable to use a waste heat boiler as a final stage behind the expander. If so, it will be small and low cost compared to a boiler that would be required for the energy in the entire flow.

A waste heat boiler could be used as a total replacement for the steam turbine, expander and high-pressure compressor for combustion air. Pressurized hydrogen from storage could be let down through an expander to a pressure level just suitable for firing into a boiler. Air would be supplied to the hydrogen combustor by a blower or fan and all the energy would be recovered in the boiler water tubes. This is the conventional way of doing it now. It becomes an economicchoice between the high cost of a larger boiler and an inefficient fuel use versus the more expensive steam turbine, expander and small boiler with higher efficiency.

Another set of embodiments takes advantage of the ability to burn H₂ using advanced power cycle(s) that will improve the economics of the entire electrical generation system more efficient management of the power generating cycle. Currently, it is expensive to install equipment at power plants to prevent emission; however, the plants have generally complied, and the marginal cost was added into the electric rate. Thus, it all worked out. Removing carbon, however, will cost proportionally more because the content is greater. Processing fossil fuel into hydrogen and storing the hydrogen for 12-16 hours off-peak and then generating electricity on-peak when needed can lead the industry out of the conundrum of having existing assets needed for security and reliability, but unable to operate economically.

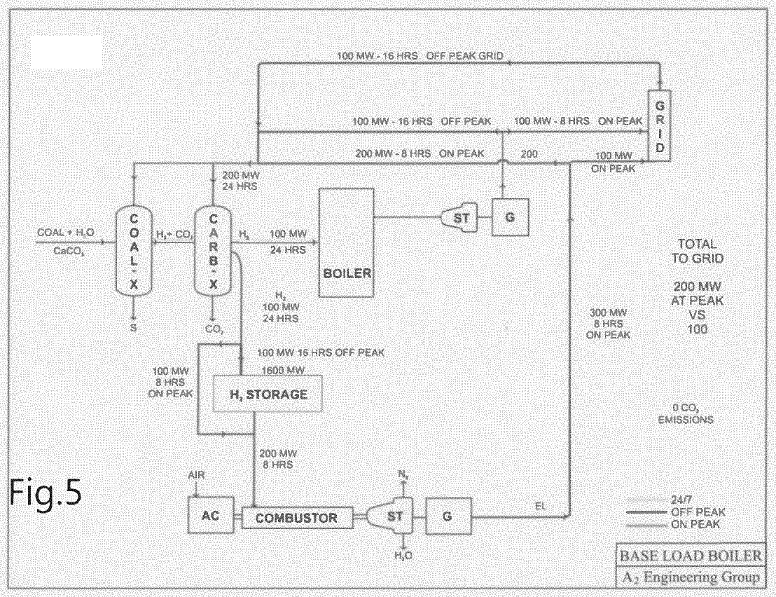

As described above embodiments for power cycles are illustrated herein—as a “coal baseload” (FIG. 5).

For example: An existing 100 MW coal plant built to operate 24/7 is now probably operating only at ⅓ capacity for 12-16 hours and is ramped up to 100 MW for only 8-12 hours. Because of this sporadic operation, the internal steel and refractory in the boiler is deteriorating due to the heating and cooling causing expansion and contraction. Because there really is no demand for off-peak power and because a plant must operate and can't conveniently be shut down, the electric rate is extremely low, and some power plants even pay to have someone take the off-peak power off their hands. Such a scenario could mean the plant the is likely headed for closure.

The power cycles of this invention provide an alternative, a COAL-X gasifier (as described above) with carbon capture, and hydrogen storage. The plant can then be operated 24/7 burning hydrogen derived from coal in the gasifier; CO₂ is captured and sequestered. The hydrogen is stored for 16 hours off-peak. The Coal-X unit incorporates a 300 MW hydrogen/air burning turbine. Operating for only 8 hours on-peak, it delivers 100 MW to the grid. The base plant delivers 100 MW for a total net to the grid of 200 MW on-peak. The balance 200 MW from the hydrogen turbine goes to operate the gasifier on-peak. This uses hydrogen from storage that was produced from off-peak power from the grid. It works equally as well for gas turbine or nuclear plants and possibly wind and solar. Off-peak electrical energy from the grid to power the gasifier is much more efficient than electrolysis and is the key to making the process economical. Further efficiencies are achieved in the hydrogen/air combustor that exhausts directly into a steam turbine, by-passing the need for a boiler. Water is recovered and nitrogen emitted to the atmosphere.

A key to the operation of an embodiment of this invention lies in the proper mating of the capacities of the gas generation unit to the power generating unit. The gas generation unit has a capacity to produce H₂ that is 60 to 80% of that which is required to operate the power generation section at full capacity. In other words, the gas generation units will be sized to produce less hydrogen than required to run the steam turbine at full load.

It is preferred that the gas generation section be sized to provide about 75% of maximum demand (of the turbines) and run at full capacity 100% of the time. To illustrate the way in which the process works, during off-peak times when electrical generating capacity exceeds demand by 35%, hydrogen is stored for the entire off-peak period (for example, in a pipeline, pressure vessel, or underground storage). The off-peak period will normally be about 50% of the time. When peak capacity is required, hydrogen is withdrawn from storage. This 25% capacity along with the extra 25% capacity above off-peak demand is burned in the combustor, which is rated at 100%. The burner and steam turbine have the capability to cycle between 50 and 100% demand.

In summary: the gas generation unit is sized for 65% demand. When the demand is 0%, 65% of the demand hydrogen from the gasification unit output is stored. When demand returns to 100%, the 25% is withdrawn from storage and with 75% gasifier capacity feeds the 100% burner and steam turbine.

It will be obvious and easy to determine the respective capacities and percentage of stored hydrogen when the gas generation unit is sized at other than 65% (within the 60 to 80% of gas generation capacity limits

The foregoing description of hydrogen production and use is directed at utilities and independent generators because their adoption will have the greatest impact. A different approach is used for the commercial and residential sector. A DOE study shows how hydrogen can be blended into the natural gas pipeline network to reach every burner. The hydrogen production plant will be located near an enhanced oil recovery (EOR) project, CO₂ pipeline, or DOE sponsored CO₂ sequestration site so that the CO₂ can be disposed of with little transportation cost Due to the mass of natural gas in the pipeline system, the percentage of hydrogen injected will be small at first. As the percentage exceeds 20%, some of the burners may have to be modified. Every cubic foot of natural gas converted to hydrogen and burned will eliminate one cubic foot of CO₂. Fully adopted, these processes can return CO₂ levels back to 350 ppm levels.

Although the invention hereof has been described by way of preferred embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

1. A process for generating electricity comprising:
converting carbon to hydrogen and carbon dioxide in a gas generating unit and removing the carbon dioxide, compressing and the resulting hydrogen and;
combusting it in a high-pressure combustor; passing the resulting gas product to a steam turbine connected to an electrical generator.

2. The process of claim 1 wherein the capacity of the gas generating unit is sized to produce 60 to 80 percent of the hydrogen needed to operate the steam turbine at full rated capacity and wherein excess hydrogen from the gas generation unit is stored when the electrical generating capacity of the generator exceeds demand and utilizing the stored hydrogen to add additional feed to the burner when electrical generating demand exceeds the capacity of hydrogen afforded by the gas generating unit.

3. The process of claim 1 wherein converting carbon to hydrogen and carbon dioxide is accomplished in a process comprising:
gasification of coal and coke to produce a gas containing H₂ and CO₂ in a molten chloride salt mix of KCl and CaCl at about 1700° F. and the CO₂ is removed from the gas so produced by contacting with a molten salt mixture comprising lithium ortho silicate (Li4SiO₄) maintained at about 1075° F.

4. The process of claim 3 wherein finely ground limestone is added to the salt as sulfur absorbent.

5. The process of claim 1 wherein converting carbon to hydrogen and carbon dioxide is accomplished in a process comprising:
gasification of natural gas to produce a gas containing H₂ and CO₂ in tubular reactor having tubes containing a suitable catalyst, the tubes of which are submerged in a molten salt bath maintained at about 1300° F. to provide 1200° F. inside the tubes of the tubular reactor.

6. A combination process for producing hydrogen comprising;
converting coal to hydrogen in a first reactor containing a molten salt comprising a metal chloride salt at elevated temperature sufficient to maintain the salt in molten form and passing the resulting H₂ to a second reactor containing a molten carbonate salt plus LiCO₄SiO₄ to remove CO₂ from the hydrogen.

7. The process of claim 6 wherein the temperature in the first reactor is maintained at about 1700° F.

8. The process of claim 6 wherein the salt m in the first reactor is KCl, CaCl or a mixture thereof.

9. The process of claim 6 wherein the salt in the second reactor is LiCO₃, KCO3, NaCO₃ or a mixture thereon, and the temperature of the salt is maintained at about 1000 to 1200° F.

10. The process of claim 6 wherein the LiCO₄SiO₄ in the second reactor is produced in situ by reacting nano sized particles of with 2 two parts of lithium carbonate at about 1600 to 1700° F. silicon dioxide

11. The process of claim 6 when the hydrogen is also passed through a third reactor containing a molten metal oxide to remove sulfur compounds.

12. The process of claim 11 wherein the salt in the third reactor is a metal hydroxide or carbonate and the temperature is maintained at about 1500 to 1550° F.

13. A process for producing hydrogen by reacting steam and natural gas in tubes containing steam methane reformer catalyst wherein the tubes are submerged in a molten salt bath and passing the resulting H₂ to a second reactor containing a molten carbonate salt plus LiCO₄SiO₄ to remove CO₂ from the hydrogen.

14. The process of claim 13 wherein the salt in the second reactor is LiCO₃, KCo3, NaCO₃ or a mixture thereon, and the temperature of the salt is maintained at about 1000 to 1200° F.

15. The process of claim 13 wherein the LiCO₄SiO₄ in the second reactor is produced in situ by reacting nano sized particles of with 2 two parts of lithium carbonate at about 1600 to 1700° F. silicon dioxide

16. The process of claim 13 when the hydrogen is also passed through a third reactor containing a molten metal oxide to remove sulfur compounds.

17. The process of claim 13 wherein the salt in the third reactor is a metal hydroxide or carbonate and the temperature is maintained at about 1500 to 1550° F.

18. The process of claim 13 the steam methane reformer catalyst is a nickel based catalyst.
